(19) United States
(12) Patent Application Publication
(10) Pub. No.: US 2018/0157769 A1
(43) Pub. Date: Jun. 7, 2018

(54) MULTI-REFERENCE INTERFACE INHERITANCE FOR CONCURRENT CAD INTEROPERABILITY APPLICATIONS

(71) Applicant: Brigham Young University, Provo, UT (US)

(72) Inventors: Daniel Staves, Orem, UT (US); Kelly Eric Bowman, Provo, UT (US); W. Edward Red, Provo, UT (US); Joshua Coburn, Orem, UT (US)

(21) Appl. No.: 15/601,994

(22) Filed: May 22, 2017

Related U.S. Application Data
(60) Provisional application No. 62/310,924, filed on Mar. 21, 2016.

(51) Int. Cl. G06F 17/50; G06T 19/20

(52) U.S. Cl. CPC G06F 17/50; G06F 2217/04; G06T 2219/024; G06T 19/20

(57) ABSTRACT

A computer-implemented method for storing CAx data includes storing a model of an engineering object within a CAx database, receiving a request to add a feature to the model of the engineering object, verifying each parameter associated with the request against an object oriented interface corresponding to the parameter, and adding the feature to the model of an engineering object within the CAx database. Each parameter may reference a class object within the CAx database. Verifying each parameter may include verifying the class object against the object oriented interface corresponding to that parameter. A corresponding system and computer program product are also disclosed herein.

### CROSS-REFERENCE TO RELATED APPLICATIONS

This application claims the benefit of U.S. provisional application 62/310,924 entitled “Multi-Reference Inheritance Using Interfaces” and filed on 21 Mar. 2016. The foregoing application is incorporated herein by reference.

### BACKGROUND

The subject matter disclosed herein relates to computer aided technologies (CAx) such as computer aided design, engineering, analysis and manufacture in general and apparatus, systems, means, and methods for multi-user CAx editing in particular.

Large design and engineering projects require coordination of the efforts of many designers or engineers, and efficient utilization of their efforts calls for multi-user CAx systems that allow designers and engineers to simultaneously work on a model. CAx models contain many hierarchical data structures. Features within parts within assemblies within the model may form a complex hierarchy of dependencies.

Existing CAx systems, however, are not well-suited to multi-user design and editing. For example, various CAx systems may have different views of the model and different, potentially incompatible, approaches to representing the hierarchy of features, parts, and assemblies within the model. A related issue is that the data hierarchy within a design model may lead to significant delays in the design and engineering process while CAx systems render views of the model.

Given the foregoing, what is needed is additional and improved systems and methods for computer-assisted design and analysis of engineering objects, in particular, systems and methods for conducting multiuser CAx operations. The embodiments disclosed herein were developed in response to these issues.

### SUMMARY OF THE INVENTION

As will be described in greater detail below, the subject matter disclosed herein describes various systems and methods for managing CAx data. In one embodiment, a method for storing CAx data includes storing a model of an engineering object within a CAx database, receiving a request to add a feature to the model of the engineering object, verifying each parameter associated with the request against an object oriented interface corresponding to the parameter, and adding the feature to the model of an engineering object within the CAx database. Each parameter may reference a class object within the CAx database. Verifying each parameter may include verifying the class object against the object oriented interface corresponding to that parameter. A corresponding system and computer program product may be configured to conduct the above method.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic drawing of a system for Error! Reference source not found. in accordance with at least one embodiment of the present invention;

FIG. 2 is a functional block diagram depicting one embodiment of the system for Error! Reference source not found.

FIG. 3 is a flowchart diagram depicting one embodiment of a method for providing Error! Reference source not found.

FIG. 4 is a flowchart diagram depicting one embodiment of a method for rendering Error! Reference source not found.

FIG. 5 is a block diagram depicting a hierarchical data structure within a design model in accordance with at least one embodiment of the present invention;

FIG. 6 is a block diagram depicting a hierarchical data structure within a design model in accordance with at least one embodiment of the claimed invention;

FIG. 7 is a block diagram depicting a hierarchical data structure within a design model in accordance with at least one embodiment of the claimed invention;

FIG. 8 is a block diagram depicting a hierarchical data structure within a design model in accordance with at least one embodiment of the claimed invention;

FIG. 9 is a block diagram depicting a hierarchical data structure within a design model in accordance with at least one embodiment of the claimed invention;

FIG. 10A is a dataflow diagram depicting an example multi-user CAx database transactions;

FIG. 10B is a text diagram depicting one example of a hierarchical CAx feature;

FIG. 11 is a block diagram of another example of a hierarchical CAx feature;

FIG. 12A is a text diagram depicting one example of a process used to incorporate new features into a neutral database;

FIG. 12B is a block showing the relationship between a CAx feature and a corresponding class object;

FIGS. 13A and 13B are screen shots of a CAx editing interface; and

FIG. 14 is a text diagram showing various examples of reserved names associated with a CAx database object oriented interface.

### DETAILED DESCRIPTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, enable the module to achieve the intended purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure is generally directed to systems and methods for Error! Reference source not found. As will be explained in greater detail below, systems and methods described herein may build and maintain a hierarchical model for engineering objects that provides a build-dependent hierarchy that enables interoperation with CAx systems based on a build-independent hierarchy or a non-hierarchical model. The hierarchical model may also provide for efficient rendering of views of an engineering object.

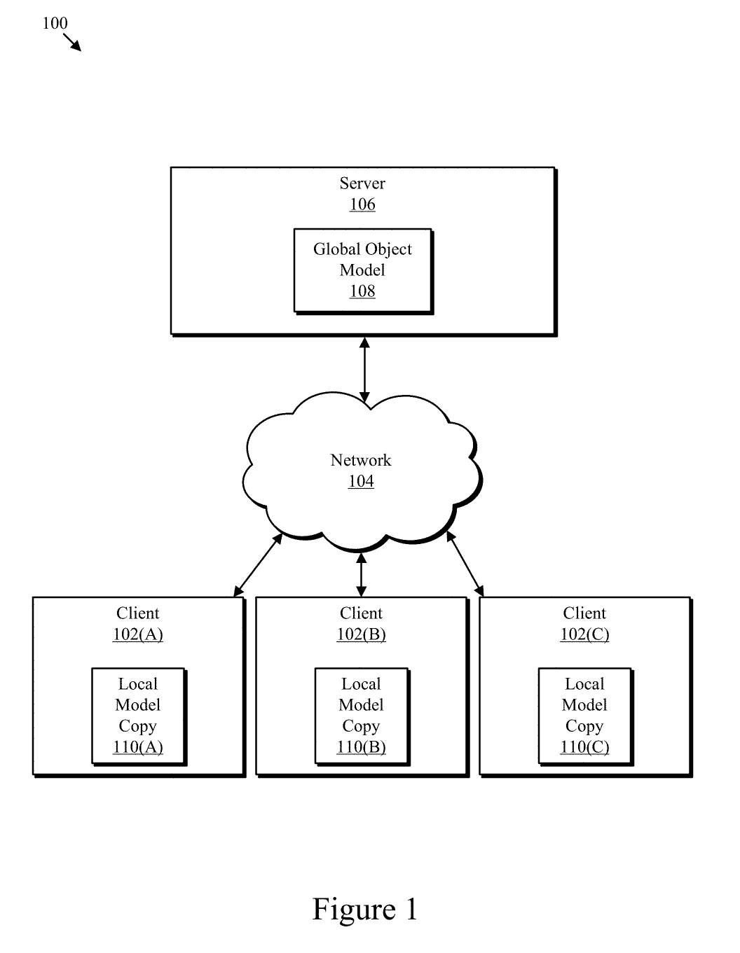

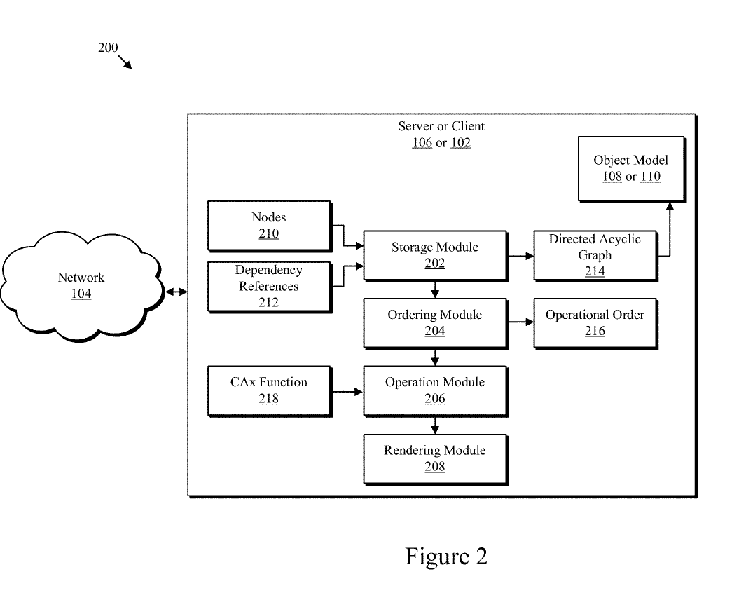

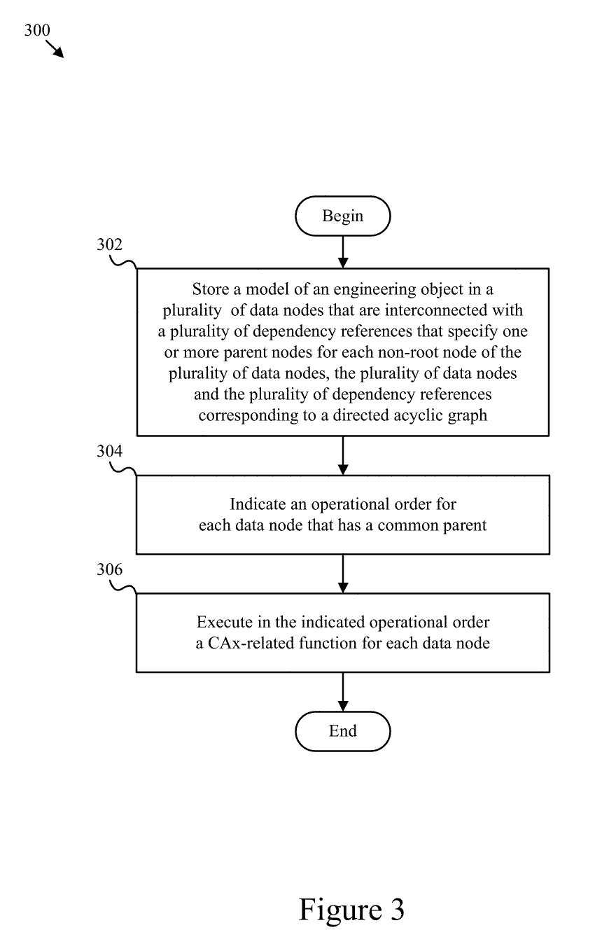

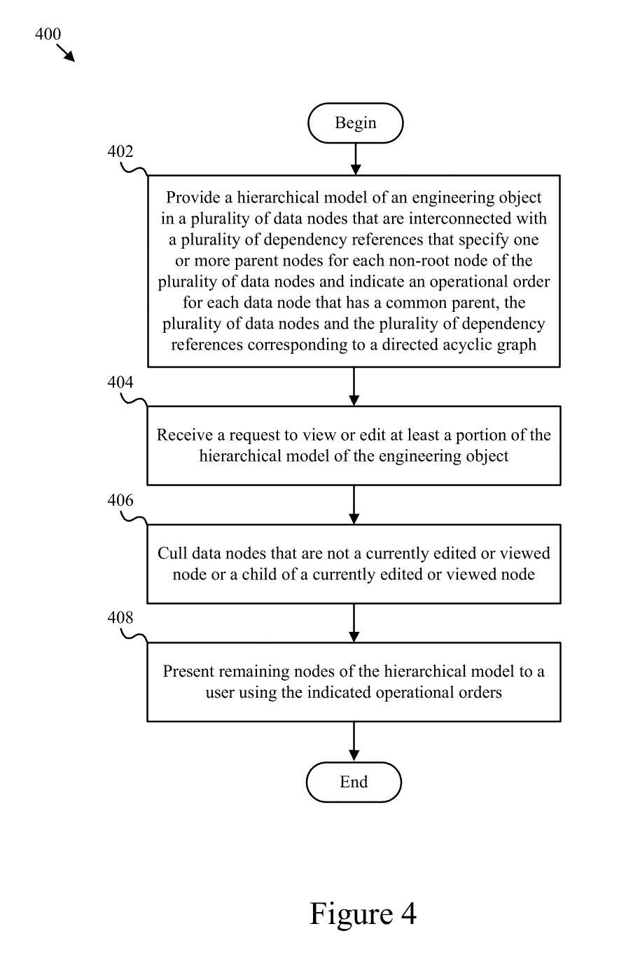

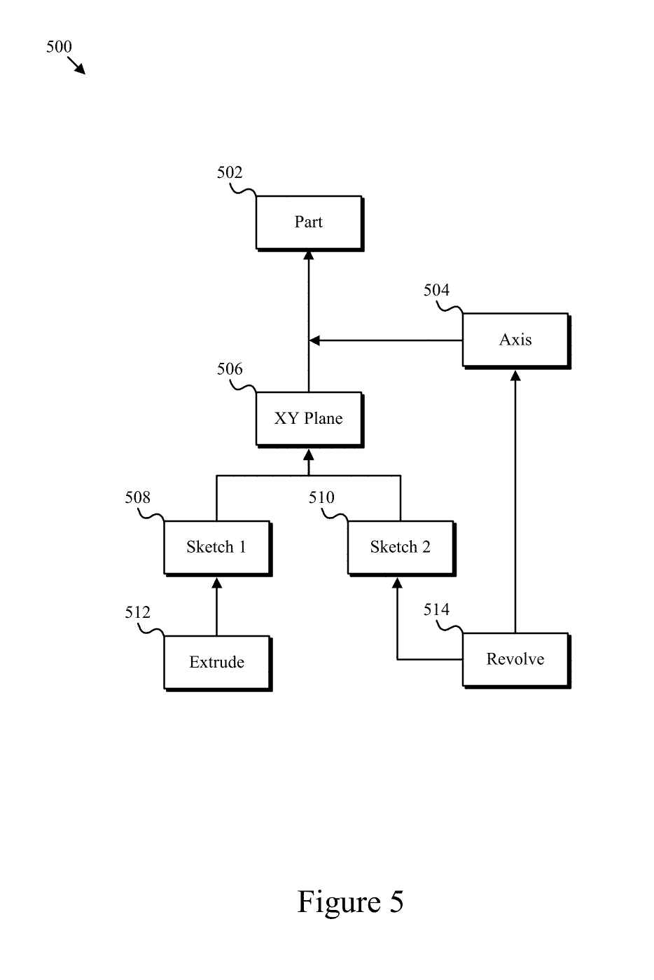

The following will provide, with reference to FIGS. 1, and 2, detailed descriptions of example systems for Error! Reference source not found. Detailed descriptions of corresponding computer-implemented methods will also be provided in connection with FIGS. 3 and 4. Specific examples of CAx operations that leverage the disclosed systems and methods are presented in FIGS. 5-9.

FIG. 1 is a schematic drawing of a system 100 wherein multi-user CAx editing may be deployed. As illustrated in this figure, system 100 may include one or more clients 102, a network 104, and a server 106. Server 106 may host a shared (i.e., global) object model 108. Clients 102 may host local model copies 110 that include at least of portion of object model 108.

Clients 102 generally represent any type or form of computing device capable of reading computer-executable instructions. Examples of clients 102 include, without limitation, laptops, tablets, desktops, servers, combinations of one or more of the same, or any other suitable computing device.

Server 106 generally represents any type or form of computing device or combinations of computing devices that is capable of storing, comparing, and/or providing data, as well as providing back-end processing services. Server 106 may represent a commercial or publicly-accessible service or a service provided to a single organization. Examples of server 106 include, without limitation, high-performance clusters, virtual machines, application servers, web servers, and/or database servers configured to provide various database services and/or run software applications, or combinations of one or more of the same.

In certain embodiments, server 106 may represent combinations of software applications and physical computing systems configured to perform various tasks. For example, server 106 may include a database server that manages one or more databases, such as global object model 108. In one example, object model 108 may be configured to store geometry, material, load, and/or environment data representing one or more design models. Object model 108 may represent portions of a single database or computing device or a plurality of databases or computing devices capable of being accessed by computing devices included in server 106 and/or clients 102.

Network 104 generally represents any medium or architecture capable of facilitating communication or data transfer. Examples of network 104 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), or the like. Network 104 may facilitate communication or data transfer using wireless or wired connections. In one embodiment, network 104 may facilitate communication between clients 102 and server 106.

FIG. 2 is a functional block diagram depicting one embodiment of a system 200 for providing Error! Reference source not found. As illustrated in this figure, system 200 may include a client 102 that may include local model copy 110 or a server 106 with a global copy 108, as well as one or more modules for performing one or more tasks. For example, and as will be explained in greater detail below, system 200 may include a storage module 202 that may store a model of an engineering object in a plurality of data nodes that are interconnected with a plurality of dependency references that specify one or more parent nodes for each non-root node of the plurality of data nodes, the plurality of data nodes and the plurality of dependency references corresponding to a directed acyclic graph. Ordering module 204 may indicate an operational order for each data node that has a common parent. Operation module 206 may execute in the indicated operational order a CAx-related function for each data node. Rendering module 208 may render a portion of the model of the engineering object. The system 200 is one particular embodiment of the system 100.

FIG. 3 is a flow diagram of an example computer-implemented method 300 for providing Error! Reference source not found. The steps shown in FIG. 3 may be performed by any suitable computer-executable code and/or computing system. In some embodiments, the steps shown in FIG. 3 (as well as FIG. 4) may be performed by the server 106, one or more clients 110, or partitioned across the server 106 and one or more clients 110.

As illustrated in FIG. 3, at step 302, one or more of the systems described herein may store a model of an engineering object in a plurality of data nodes that are interconnected with a plurality of dependency references that specify one or more parent nodes for each non-root node of the plurality of data nodes, the plurality of data nodes and the plurality of dependency references corresponding to a directed acyclic graph. For example, storage module 202 may, as part of computing device server 106 or client 100, store a model of an engineering object in a plurality of data nodes 210 that are interconnected with a plurality of dependency references 212 that specify one or more parent nodes for each non-root node of the plurality of data nodes 210, the plurality of data nodes 210 and the plurality of dependency references 212 corresponding to a directed acyclic graph 214.

The term “data nodes,” as used herein, generally refers to elements in a design model hierarchy that represent features, parts, assemblies or functions that operate on these elements. The term “dependency references,” as used herein, generally refers to parent-child relationships between nodes in the design model hierarchy, represented in a graph of the design model by edges connecting the nodes. The term “directed acyclic graph,” as used herein, generally refers to a representation of the data nodes of the design model hierarchy, connected by edges representing the dependency references.

Storage module 202 may store the model of the engineering object in a variety of ways. For example, storage module 202 may include in the data structure representing each node a reference to the node's parent node. As will be described in greater detail below, storage module 202 may also include in the data structure representing each node an index that may be used to store the build order for multiple child nodes of a common parent. In one embodiment, each dependency reference may include one or more of (1) a pointer, (2) a handle, and/or (3) an index.

FIG. 4 is a flow diagram of a computer-implemented method 300 for rendering Error! Reference source not found. As depicted, the method includes providing (402) a hierarchical model, receiving (404) a request to view or edit at least a portion of the hierarchical model, culling (406) data nodes, and presenting (408) remaining nodes using the indicated operational orders. The method 400 may be conducted the server 106, one or more clients 110, or partitioned across the server 106 and one or more clients 110.

Providing (402) a hierarchical model may include storing a model of an engineering object in a plurality of data nodes that are interconnected with a plurality of dependency references that specify one or more parent nodes for each non-root node of the plurality of data nodes, the plurality of data nodes and the plurality of dependency references corresponding to a directed acyclic graph. For example, storage module 202 may, as part of computing device client 102 or server 106 in FIG. 2, store a model of an engineering object in a plurality of data nodes 210 that are interconnected with a plurality of dependency references 212 that specify one or more parent nodes for each non-root node of the plurality of data nodes 210, the plurality of data nodes 210 and the plurality of dependency references 212 corresponding to a directed acyclic graph 214.

As in step 302 in FIG. 3, storage module 202 may store the model of the engineering object in a variety of ways. For example, storage module 202 may include in the data structure representing each node a reference to the node's parent node. Storage module 202 may also include in the data structure representing each node an index that may be used to store the build order for multiple child nodes of a common parent. Each dependency reference may include one or more of (1) a pointer, (2) a handle, and/or (3) an index.

Receiving (404) a request to view or edit at least a portion of the hierarchical model may include receiving a request to render at least a portion of the model of the engineering object. For example, rendering module 208 may, as part of client 102 or server 106 in FIG. 2, receive a request from client 102 to render a portion of object model 108. Rendering module 208 may receive the request to render a portion of the engineering object in a variety of ways. For example, user of a CAx system may select an assembly or part for rendering. The CAx system may identify the subtree of the hierarchical model representing the assembly or part to rendering module 208, along with parameters of the view to be rendered. Rendering may take place on the client or server, depending on whether the client database has the portion of the model hierarchy containing the subtree for the selected part or assembly.

Culling (406) data nodes may include culling nodes that are not a currently edited or viewed node or a child of a currently edited or viewed node. Server 106 may pre-cull elements related to a view, such that elements that are fully contained within another bounding box are culled. The server may store views of features, parts, and/or assemblies in the database with non-visible elements pre-culled. Doing so would enable the server to provide a view of each feature, part, or assembly without the time and processing overhead associated with rendering the view at the time the view is requested.

The server may also store a simplified view of features, parts, and/or assemblies, so that users may be presented with a simplified view of elements they are not permitted to interact with. For example, a user may not be permitted to obtain a detailed view of an element restricted under the International Traffic in Arms Regulations (ITAR) laws. The server may provide users restricted under ITAR with a compliant, simplified view of the restricted elements.

Presenting (408) remaining nodes may include presenting a graphical rendering of the remaining nodes to a user. The graphical rendering may be generated using the indicated operational orders in order to maintain integrity of the hierarchical model.

FIG. 5 is a block diagram depicting a hierarchical data structure 500 within a design model. Hierarchical data structure 500 may include a part node 502 at the root of the graph, an axis node 504, an XY plane node, two sketch nodes 508 and 510, an extrude node 512, and a revolve node 514. The nodes represent the features (e.g., geometries and operations) that constitute the part represented by part node 502 at the root of the graph. Hierarchical data structure 500 forms a consistent, hierarchical tree in which each node has an operational order beneath its parent. As such, hierarchical data structure 500 may be suitable for build-dependent hierarchy storage. Hierarchical data structure 500 may be a subtree of a larger design model, in which several parts comprise a build-dependent hierarchy of an assembly. As CAx clients combine the elements comprising a part or assembly, the CAx systems running on the clients may assign data nodes to be child nodes to a parent data node, and subsequently reassign a child data node to a different parent data node.

At step 304, one or more of the systems described herein may indicate an operational order for each data node that has a common parent. For example, ordering module 204 may, as part of server 106 in FIG. 2, indicate an operational order 216 for each data node 210 in directed acyclic graph 214 that has a common parent.

Ordering module 204 may indicate an operational order for each data node that has a common parent in any suitable manner. For example, ordering module 204 may indicate an operational order by storing a priority level in each node data structure that is a child node of a common parent. In another example, ordering module may set a link field in each child node of a common parent that links each child node to the next node in operational order.

In one embodiment, the model is stored on a server and a client requests a particular position within the operational order. For example, client 102 may request a particular position within operational order 216 from ordering module 204 for a particular data node 210. Ordering module 204 may assign an operational order to each child node of a common parent according to the request from the client. Ordering module 204 may then inform the client of the assigned operational order. If necessary, the client may then adjust the operational order in the local copy of the model database. Ordering module 204 may, when necessary, resolve conflicts between operational order requests from two or more clients submitting operational order requests for child nodes of a common parent and notify each client of the assigned operational order for the child nodes.

At step 306, one or more of the systems described herein may execute in the indicated operational order a CAx-related function for each data node. For example, operation module 206 may, as part of server 106 in FIG. 2, execute in the indicated operational order 216 a CAx function 218 for each data node 210 in directed acyclic graph 214.

Operation module 206 may execute CAx-related functions for each data node in the indicated operational order in a variety of ways. In some examples, systems described herein may include executing a dependency-related function according to the dependency references. For example, operation module 206 may utilize index and operational order fields in each data node to determine the order of operations for all data nodes in a hierarchy. The tree structure of the hierarchy may increase the efficiency of executing CAx-related functions for data nodes in the hierarchy by enabling the hierarchy tree to be partitioned into subtrees. The subtrees may be processed in parallel with different processors using algorithms that operate on subtrees.

In one embodiment, the dependency-related function may include checking for potential conflicts. Operation module 206 may perform a conflict checking and resolution operation on the hierarchical model of the engineering object or on a subtree within the hierarchical model.

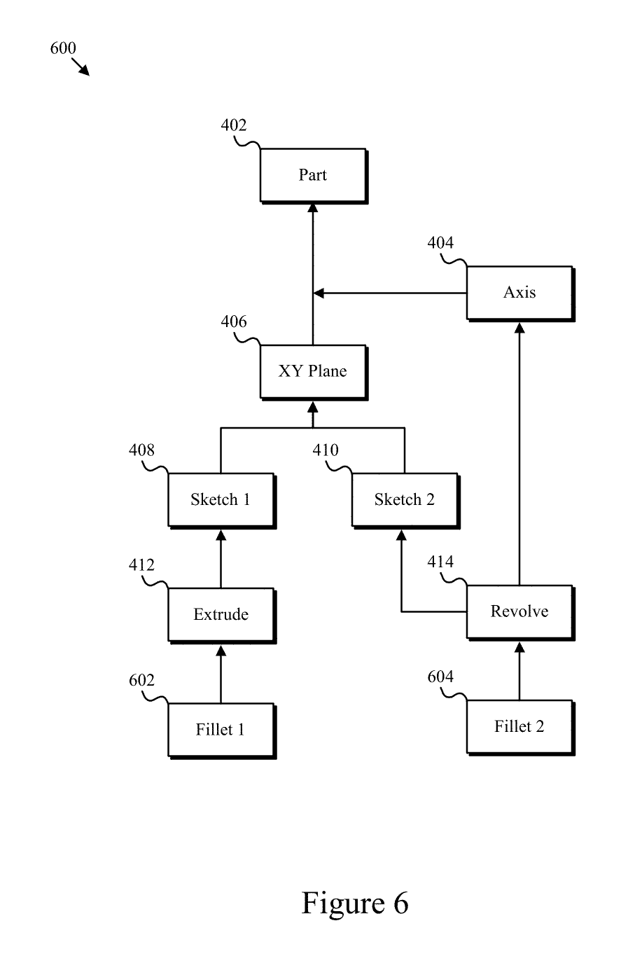

In one embodiment, data nodes that do not have a common parent are determined to not have a potential conflict. FIG. 6 is a block diagram depicting a hierarchical data structure 600 within a design model. Hierarchical data structure 600 includes the data nodes of hierarchical data structure 500 in FIG. 5, with the addition of two fillet operation data nodes 602 and 604. Because fillet operation node 602 and fillet operation node 604 have different parent nodes, a conflict checking and resolution operation performed by operation module 206 may determine that there is no potential conflict between the two nodes.

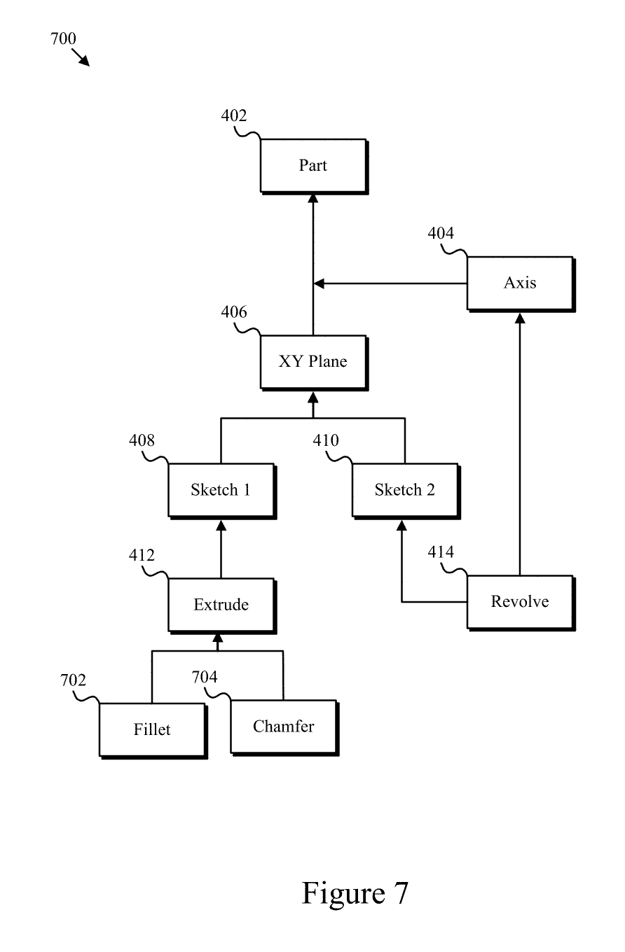

FIG. 7 is a block diagram depicting a hierarchical data structure 700 within a design model with a conflict between two operation data nodes, fillet node 702 and chamfer 704. If two clients were to separately add the two operation nodes, ordering module 204 may recognize that the order in which the two operations are performed may produce different geometries. Ordering module 204 may resolve the conflict by assigning the operation order for the two operation data nodes that results in the correct geometry.

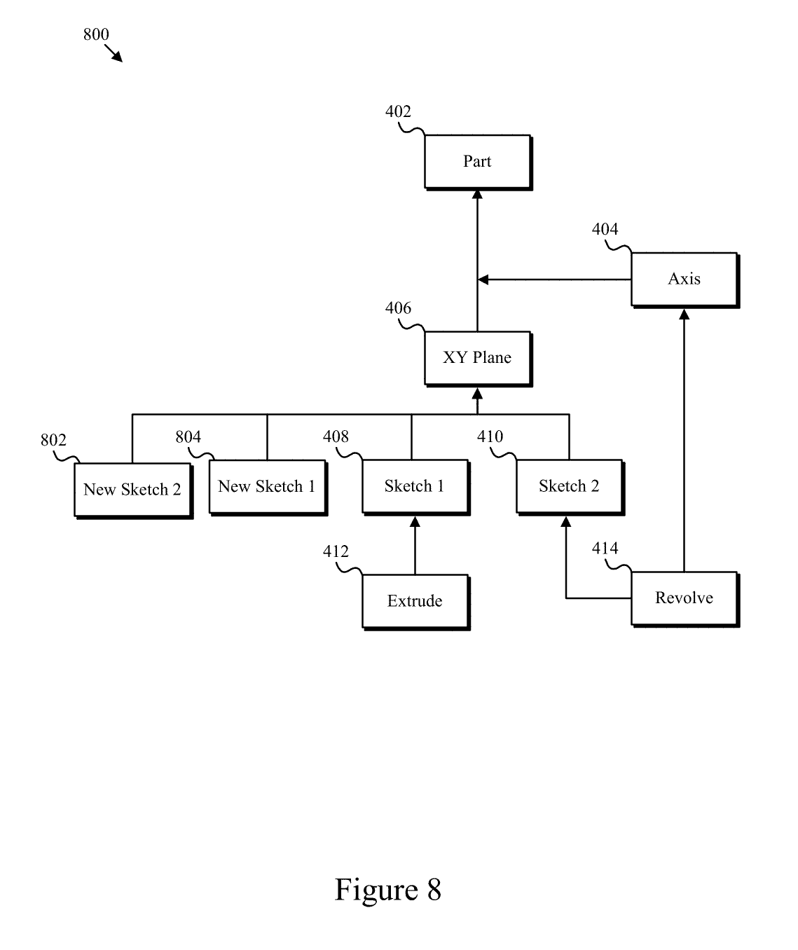

In some examples, operation order may be unimportant. FIG. 8 is a block diagram depicting a hierarchical data structure 800 within a design model. The additional sketch data nodes 802 and 804 may be added to the XY plane of the parent node in any order without conflict or incompatibility.

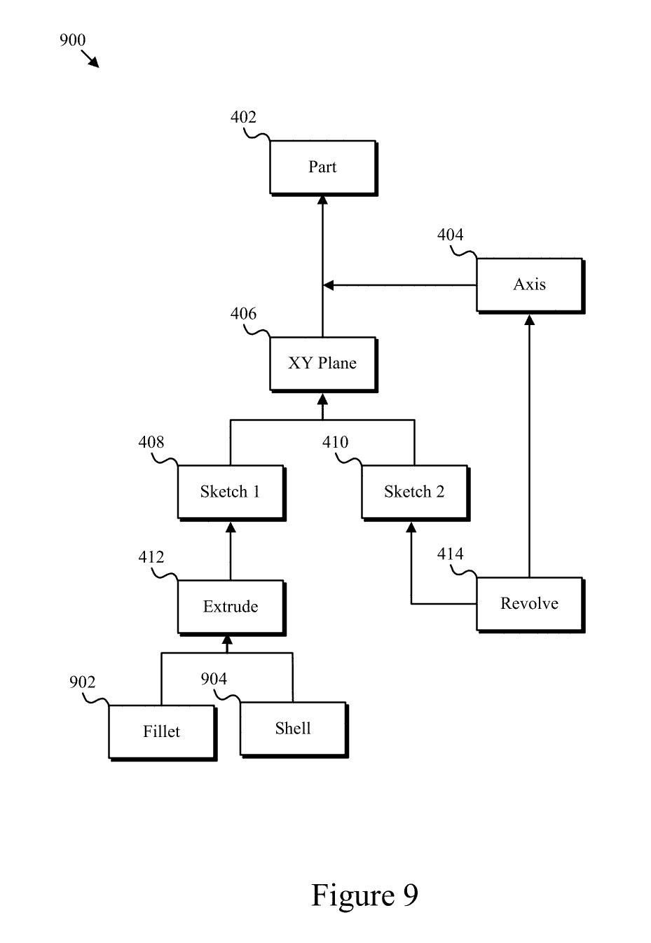

In some examples, operation order does not lead to a correct or incorrect build of a geometry, rather the operation order results in two correct, but different, geometries. For example, FIG. 9 is a block diagram depicting a hierarchical data structure 900 within a design model. The order in which the operations represented by fillet node 902 and shell node 904 are executed may result in two different geometries. In this example, ordering module 204 may assign an operational order according to the order in which the operation nodes were added to the hierarchical data structure. If the two operations were added to the hierarchical data structure by separate clients at approximately the same time, ordering module 204 may notify the clients of the potential ambiguity, so that the clients may determine the operational order that results in the intended design.

In one embodiment, the CAx-related function may include graphically rendering at least a portion of the model of the engineering object. FIG. 4 is a flowchart diagram depicting one embodiment of a method 400 for rendering Error! Reference source not found. The steps shown in FIG. 4 may be performed by any suitable computer-executable code and/or computing system. In some embodiments, the steps shown in FIG. 3 may be performed by one or more of the components of system 100 in FIG. 1 or system 200 in FIG. 2.

By maintaining data nodes in a hierarchical tree graph in which child nodes of a common parent are assigned an operational order, systems and methods described herein create interoperable storage for engineering designs. For CAx tools that use build-dependent hierarchical storage, systems and methods described herein maintain an operational order for child nodes with a common parent, to provide a consistent view of the engineering object to all users. The build-dependent hierarchical storage model may also interoperate with build-independent CAx tools or non-hierarchical CAx tools

The hierarchical storage model constructed and maintained by systems and methods described herein may also facilitate efficient rendering of all or a portion of an engineering model, as well as efficient and compliant rendering of database elements restricted under ITAR.

In some embodiments, CAx operations and associated data are stored in a database and CAx operations and associated data are passed between clients through one or more servers which track operation order. During the multi-user, collaborative modeling process, CAD operation data is passed between clients through one or more servers which track operation order. As CAD operations are received by clients, the geometric calculations defined by the operations are performed in order, and the generated geometries are incorporated into the local model. Part models may be created and remain synchronized because these remote operations happen concurrently with the local operations. When a client first enters an previously-existing model, however, operation data performed before entering the model must be applied before any local modeling operations are performed.

A database may be used to record CAx operations as they are performed by clients and routed through the servers. The database acts as a persistent storage for the assembly and part models because it stores all operations used to create the model. During the initial load of a model by a client, the server loads all stored operations pertaining to the model from the database and sends them to the client to be performed locally. The database is only accessed during this initial loading event. All other remote operations are directly forwarded by the server(s) from remote clients to increase the transfer rate of modeling messages. Modeling operations received by the server(s) for distribution are recorded in the database for persistent storage. During part model loading, the server accesses modeling operation data from the database for part model synchronization of new client.

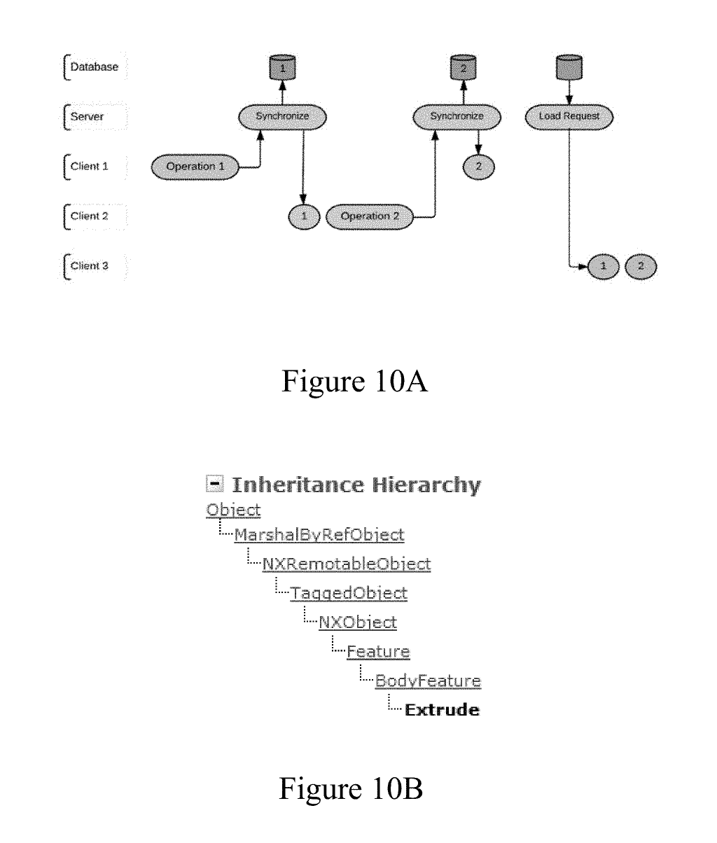

An example of how database transactions are used during the multi-user modeling process is illustrated in FIG. 10A. In this example, clients 1 and 2 are working collaboratively in a part model. As client 1 performs operation 1, operation data is sent to the server to be forwarded to client 2. While the server is forwarding the operation data, it also writes that data to the database for persistent storage. This work flow enables quick response times between operations because the model synchronization doesn't need to wait on the database save operation. This process is repeated when client 2 performs operation 2. When client 3 joins the part modeling session some time later, before they are able to perform any modeling commands, the server queries the database for all modeling operations associated with the part model and sends them to be applied to the local model. In this manner, clients models are synchronized while keeping database queries at a minimum.

For heterogeneous multi-user CAx scenarios, the database is designed to store CAx data at its most basic level. In addition, the database must enforce referential integrity to reject invalid data. Modern CAx applications utilize feature operations to build parametric models. Features in a CAx system are defined using various parameters, and depending on the function of the feature, may accept different types of parameters. In the CAx system's API, these features, and variations of features, are arranged in a hierarchical order. FIG. 10B shows an example of the hierarchical structure for the NX 8.0 API, where an extrude feature is a child object of other CAD objects.

Features that share similar characteristics and parameters are grouped together. To facilitate this kind of data storage while enforcing data integrity in the database, parameters relating to each CAx feature are distributed between database tables of varying generality. These tables are shared by other features which use the same parameters. For example, both a 2D sketch feature and a plane feature have a feature name and time stamp.

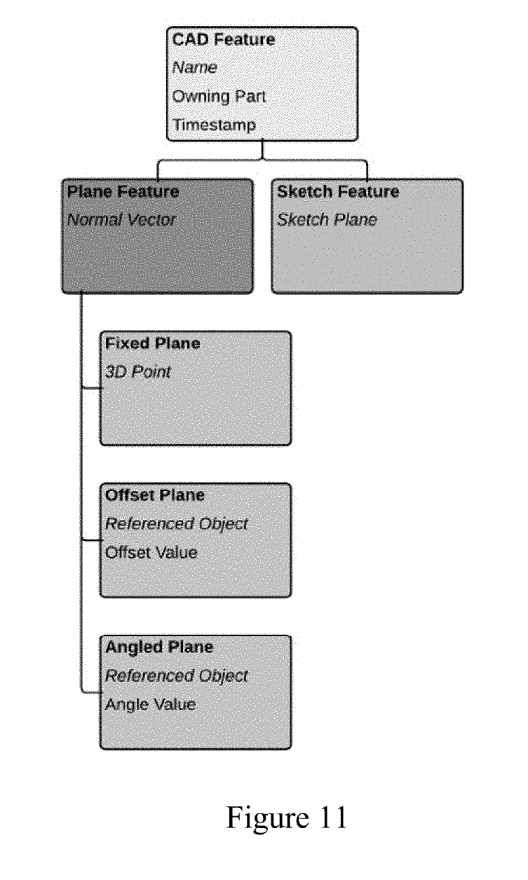

FIG. 11 depicts the hierarchy of a sketch feature and plane feature variations. All first order features reference the top CAx feature table, which contains basic parameters such as feature name, owning CAD part, and time stamp. First-order features are features which are not variations of another object. This includes sketch features and plane features. Each of these first-order feature tables contains unique parameters used to define that feature. The feature variations of the plane feature reference the first-order plane feature to gain access to the normal vector parameter. The fixed plane feature, for example, references the plane feature table and adds a 3D point parameter for defining location in 3D space, while the offset plane and angled plane features add reference parameters and offset values. Using this hierarchy, a feature or feature variation at the bottom of the hierarchy is fully defined when it combines the parameter values contained in its table with all those that it references. The offset plane table when combined with the parameters of the plane feature table and the CAx feature table contains all parameters required to define an offset plane feature.

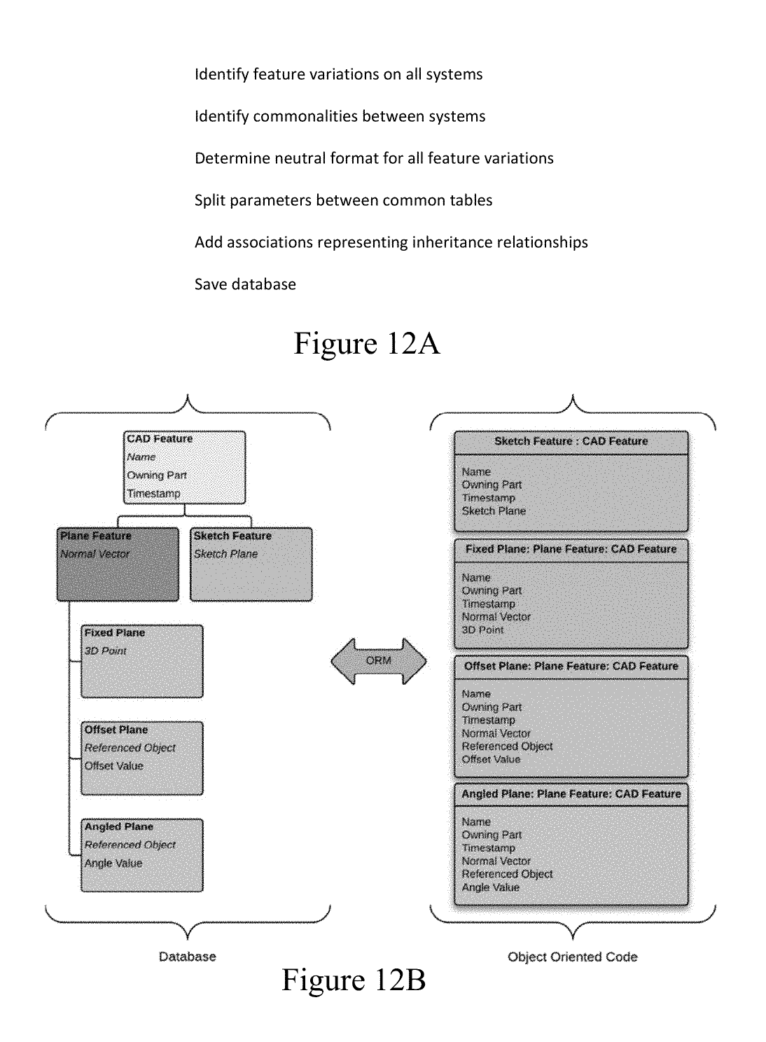

FIG. 12A describes the process used to incorporate new features into the neutral database. When a new feature is to be added, feature creation methods are identified and compared between CAx systems to identify commonalities. For example, both a blind extrude in Creo, and an extrude-by-values in NX expect a sketch feature on which the operation is to be performed and numerical limits to identify the start and end points of the extrude. Though these feature variations are given different names, and treat the limits differently, both can be neutralized into the same format without loss of data or semantic meaning. Contrasting this feature variation with an extrude-to-plane operation, both methods utilize the same sketch parameter, but accept different objects to define limits. When splitting parameters between common tables, as shown in FIG. 12A, a generic extrude table will be created which stores the referenced sketch parameter, and two feature variation tables will be created to hold the parameters required by the blind extrude and planar extrude respectively.

When arranged in this manner, each variation of a feature will share parameters with other features but will have a table containing the parameters which make it unique. As shown in FIG. 12B, a plane feature can be divided into feature variations, with both an offset plane feature and a fixed plane feature sharing parameters defining normal direction. Both features also have parameters which make them unique. An offset plane feature, for example, has an offset distance parameter and an offset object, while a fixed plane has a 3D point defining its location. By arranging the database tables in this manner, data integrity is enforced because only the parametersused to define a feature variation are stored in a table. This allows the database designer to enforce all parameters as required with a defined data type. Invalid database save operations will automatically be rejected.

Besides enforcing data integrity, the arrangement of database tables into a CAx feature hierarchy also enables database parameters to store a variety of feature references. Designers use this type of reference to signify important relationships in a CAx model, implicitly defining design intent. A single parameter used to define a feature can be used to reference a wide variation of features. For example, A 2D sketch feature requires a Datum Plane as a parameter to define its location in space. Using this hierarchical method, the parameter in the sketch database table can reference the more general plane table, which contains parameters used by both the offset plane and fixed plane tables. This effectively allows a sketch to reference any of these features.

To facilitate reading from and writing to the database, an Object Relational Manager (ORM) may be used to convert data between programming objects and the database such as an SQL database. The ORM generates programming class code based on the database schema, effectively defining a neutral data structure in which CAD feature parameters are stored. When the proper methods are called, the ORM saves the parameters stored in the neutral data structure to their corresponding tables and columns in the database. These data structures defined by the ORM make up the foundation of the messages sent between the clients and server.

Because the ORM data structure is based on the database schema, it automatically captures all parameters and associations defined in the database tables. Since many of the associations in the database are used to define the hierarchical nature of CAD features and objects, these associations are modified within the ORM to represent inheritance relationships for the neutral data structure.

Inheritance is a principle sometimes employed in object oriented programing to define instances where one object derives methods and properties from another object. In the API of the present CAx system, CAx feature objects may derive certain methods and properties from a base feature class. In a dispersed representation of CAx features in the database, where feature parameters for a single feature may be distributed throughout multiple tables, a feature variation inherits from a base class of that feature. By modifying the associations of the database tables imported by the ORM to represent inheritance, single programming objects are created which contain all the parameters of the features from which it is derived.

The ORM, as shown in FIG. 12B, converts the features and feature variations distributed through the various database tables into single CAD objects which contain all the parameters required to define each feature or feature variation in a neutral format. The database tables for sketch feature and for the plane feature variations are combined into their own data structures. These structures retain their relationships with the corresponding database parameters from which they are derived, and are used for accessing and writing data within the database. The hierarchy established within the database between tables is also retained in the data structures created by the ORM as object inheritance.

Apart from combining feature parameters into a single feature object, inheritance is used to define data types. Since each feature variation is represented in the database as a separate table and modified by the ORM to be represented as separate objects inheriting properties from the base feature class, each feature variation object is of the same type as the base feature object. This is an important principle which enables feature references. A 2D sketch feature in CAx, for example, references a plane feature to define location. A plane feature has multiple feature variations from which it can be defined.

Using the method describe above, the ORM will generate feature objects for each feature variation. However, since each plane feature variation inherits the base plane feature, the parameter used to reference a plane feature in the sketch feature object needs only to be of type plane object, and any variation of the plane object can be stored. This method both simplifies development and helps to preserve data integrity because only one reference parameter is needed to reference multiple feature definitions.

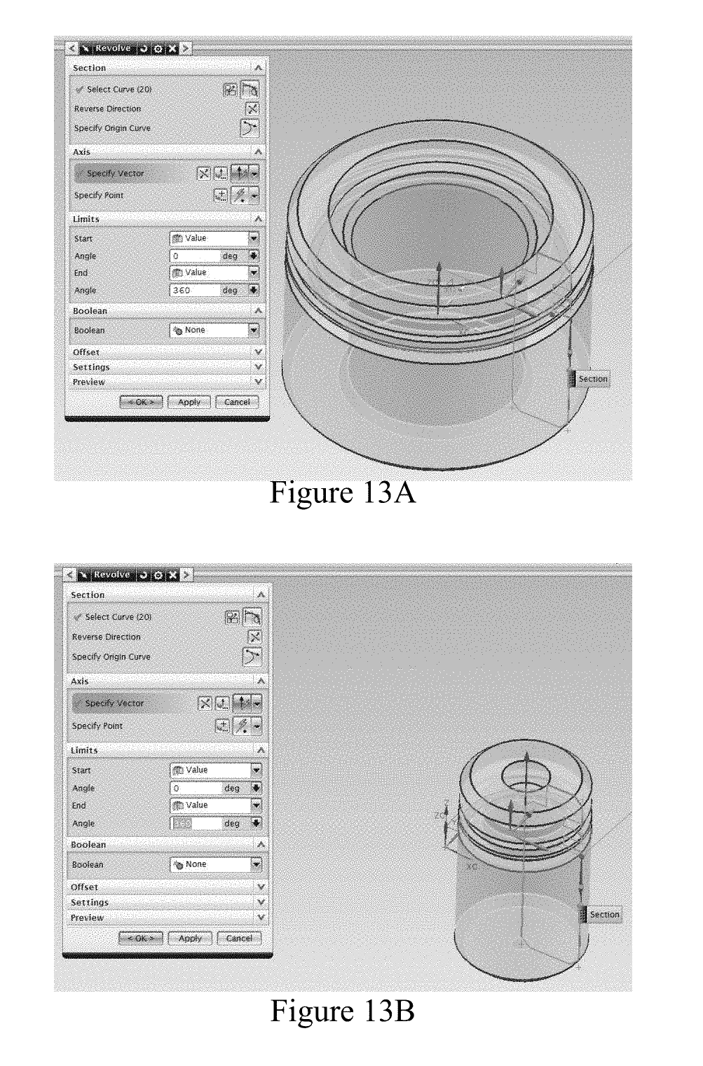

While the method described above enables multiple feature definitions to be referenced, many CAD features can reference completely different types of objects in a single parameter. This is illustrated by the example in FIGS. 13A and 13B. A revolve feature revolves a two dimensional sketch around an axis to generate three dimensional geometry. The axis of the revolve could be an axis feature, defined by a 3D point and vector, or could be a line object in a 2D sketch. These two objects in no way share an inheritance structure but must be able to be referenced in a single parameter to maintain data integrity. Further modifications to the ORM may be necessary to support this functionality. This may be accomplished by modifying the code generated by the ORM to implement an interface system. Interfaces may be used to declare functional similarities between different object types. In essence, it allows unrelated objects in code to interact with other objects in the same way. In the case of the revolve feature example, both the axis feature and the 2D line object implement an interface which denote that both objects can be used as a reference for an axis. In this case, the revolve feature axis parameter does not require a specific feature type, but instead requires an object which implements an axis interface. This may be done by modifying the part of the ORM which automatically generates the neutral data structure to include the interface code.

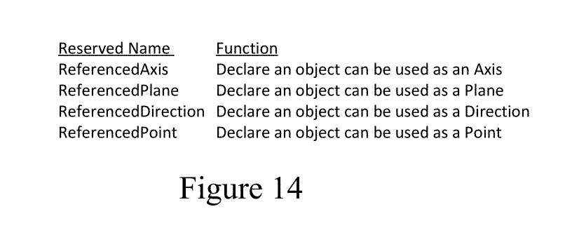

Database tables and data structures which reference an interface rather than a feature may need to be modified as well. Because each association in the database requires a single table to represent to represent the association, any feature table using a parameter to reference an interface must create the association with the most basic database table from which all feature tables associate. The parameter used for the reference may be given a reserved name which represents the type of interface used. For the case of an axis reference, the reserved name is ReferencedAxis while other reserved names can be seen in FIG. 14. The ORM is modified to identify these reserved names and replace all associated references to the basic CAD object data structure with the interface type corresponding to the reserved name.

While creating a database association with the most basic database table lowers the data integrity of the database by allowing any feature, including invalid features, to be referenced; invalid data is prevented from being added to the database by the modified ORM data structures. The data structures allow only features which implement the correct interface to be referenced. All read/write operations to the database are abstracted as far away from the user as possible to reduce the risk of data corruption. The ORM may be as close as possible to the database to ensure that future developers aren't able to make any errors and corrupt the data.

In one embodiment, a method for storing CAx data that is consistent with the above includes storing a model of an engineering object within a CAx database, receiving a request to add a feature to the model of the engineering object, verifying each parameter associated with the request against an object oriented interface corresponding to the parameter, and adding the feature to the model of an engineering object within the CAx database. Each parameter may reference a class object within the CAx database. Verifying each parameter may include verifying the class object against the object oriented interface corresponding to that parameter. A computing system and/or computer program product may be configured to conduct the above method.

It should be understood that this description is not intended to limit the invention. On the contrary, the example embodiments are intended to cover alternatives, modifications, and equivalents, which are included in the spirit and scope of the invention as defined by the appended claims. Further, in the detailed description of the example embodiments, numerous specific details are set forth in order to provide a comprehensive understanding of the claimed invention. However, one skilled in the art would understand that various embodiments may be practiced without such specific details.

Although the features and elements of the present example embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method comprising:
storing a model of an engineering object within a CAx database;
receiving a request to add a feature to the model of the engineering object;
verifying each parameter associated with the request against an object oriented interface corresponding to the parameter; and
adding the feature to the model of an engineering object within the CAx database.

2. The method of claim 1, wherein each parameter references a class object within the CAx database.

3. The method of claim 2, wherein verifying each parameter comprises verifying the class object against the object oriented interface corresponding to the parameter.
